(19) United States
(12) Patent Application Publication
(10) Pub. No.: US 2009/0001804 A1
(43) Pub. Date: Jan. 1, 2009

(54) Control and/or Regulation Device for an Elevating Platform of a Continuous Casting Machine

(75) Inventors: Ronald Wilmes, Solingen (DE); Hans Esau Klassen, Willich (DE); Bujor Dumitriu, Duesseldorf (DE); Paul-Christian Hopp, Neuss (DE); Christian Geerkens, Juechen (DE)

Correspondence Address: ABELMAN, FRAYNE & SCHWAB, 666 THIRD AVENUE, 10TH FLOOR, NEW YORK, NY, 10017, US

(73) Assignee: SMS DEMAG AG, Dusseldorf (DE)

(21) Appl. No.: 11/792,106

(22) PCT Filed: Dec. 2, 2005
(86) PCT No.: PCT/EP05/12955

§ 371 Date: Jul. 25, 2008

(30) Foreign Application Priority Data
Dec. 3, 2004 (DE) 10 2004 058 356.0

(51) Int. Cl. B60T 13/74

(52) U.S. Cl. 303/3

(57) ABSTRACT

A controlling and/or regulating device for a lifting table (10) supporting a continuous casting mold (5) in a continuous casting machine (1) for liquid metal, in particular for liquid steel material (3), with an oscillating drive (11) comprising a plurality of stationary piston-cylinder units (12) which are articulated at the lifting table (10), with field measuring devices (16) at the hydraulic cylinder (12a), the signals of which field measuring devices (16) are fed via electrical connections (21)) to the control/regulating station (25) and back into the associated actuators, is operated in a fieldized manner and requires less resources for cabling in spite of the large quantity of electrical connections (21) in that the respective electrical connections (21) are guided in the vicinity (30) of the lifting table (10) as cable bundles (23) to an axle regulator (31) which is connected, via a fieldbus (22), to a memory-programmable control (32) located at a distance in the control/regulating station (25).

The invention is directed to a controlling and/or regulating device for a lifting table supporting a continuous casting mold in a continuous casting machine for liquid metal, in particular for liquid steel material, having an oscillating drive which transmits upward motion and downward motion to the lifting table and the continuous casting mold, this upward and downward motion being generated by a plurality of stationary piston-cylinder units which are articulated at the lifting table. Field measuring devices mounted at the hydraulic cylinder comprise a valve block with a regulating valve and a plurality of pressure transducers, and a position sensor integrated in the hydraulic cylinder. The signals of the field measuring devices are fed via electrical connections to the control/regulating station and back into the associated actuators.

An oscillating drive for a continuous casting mold on a lifting table is known, for example, from DE-A1-198 45 357. In this connection, oscillating forces are measured for a basic adjustment of amplitude and frequency. Square-standing, double-action, independent hydraulic cylinders are sensed by measurement techniques and the measurement data are used for diagnosing the casting machine and/or the casting process. With regard to the required control lines and signal lines to a computing unit in the control station, there are already large quantities of signal lines for the field measuring devices (valve block, regulating valves, pressure transducers, and position sensors) for which the signal lines must be guided to and from the control station. Therefore, the basic central processing of the measurement data is a disadvantage in controls and regulators of this type.

It is the object of the invention to propose a fieldized control and/or regulation in which less cabling is required while taking into account the large distances from the control station and in spite of large quantities of signal lines.

According to the invention, the above-stated object is met in the controlling and/or regulating device mentioned in the beginning in that the respective electrical connections are guided in the vicinity of the lifting table as cable bundles to an axle regulator which is connected via a fieldbus to a memory-programmable control located at a distance in the control/regulating station. In this way, cabling is substantially reduced through the short distance between the field devices and the axle regulator. The application software in the axle regulators can be standardized. The transmission of the data between the programmable control and the axle regulator is non-critical with respect to time and is reliable.

The axle regulators are particularly important. Axle regulators are circuits which are based on special microprocessors and are used for controlling servo-axles. The standard software in the movement control adds a real-time control for the axle adjustment. The movement control includes interfaces for machine transducers or incremental position transducers, digital or analog inputs or outputs, a PROFIBUS, and a network, e.g., based on Ethernet.

The movement control used for the application of an axle regulator comprises a remote control and a data display device (display). The application software is standardized and is stored in a retrievable memory. The movement control is capable of controlling a plurality of axles (hydraulic piston-cylinder units). On the basis of a graphic menu, the movement control is adapted to the type of axle and to the type of position feedback by parameters. Programming is not necessary. The movement control receives the required reference values and starting movement via the fieldbus line connection and feeds them back to the master system with the position and a status reading. Further advantages consist in that the transmission of data between the memory-programmable control and the respective axle regulator is non-critical with respect to time and is reliable. Application software modules can be standardized. The cost of material, installation costs and the time spent on placing cable can be reduced. Susceptibility to electrical interference is reduced. Maintenance costs are likewise reduced. The time required for assembly and operation startup is reduced.

In an embodiment, the field measuring devices can be disconnected from or reconnected to the lifting table by means of a plug-in connection. In this way, the continuous casting mold can be dismantled or reinstalled quickly in an advantageous manner.

A further improvement consists in that lifting modules are formed each with two position sensors, two regulating valves and four pressure transducers. Accordingly, the controlling and/or regulating device need only process two SSI signals and six analog signals as well as some digital signals.

The axle regulators are especially important. Further features provide that the axle regulators are arranged inside a protective terminal box.

It is advantageous that the axle regulators serve for signal processing in the hydraulic circuit of the lifting table, continuous casting mold and hydraulic piston-cylinder units for acquiring, transmitting, processing and outputting the signals.

Further advantages result in that the axle regulator is connected to a cable for the power supply, a cable for the power supply of a fieldbus module, and a cable for the data of the fieldbus module.

Further, inventive features are provided in that the axle regulator is operated with standardized software in the movement control for the axle adjustment of the hydraulic cylinders with interfaces for absolute position sensors or incremental position sensors, digital or analog inputs and outputs, the fieldbus, and in a network.

An embodiment example of the invention is shown in the drawings and is described more fully in the following.

The drawings show:

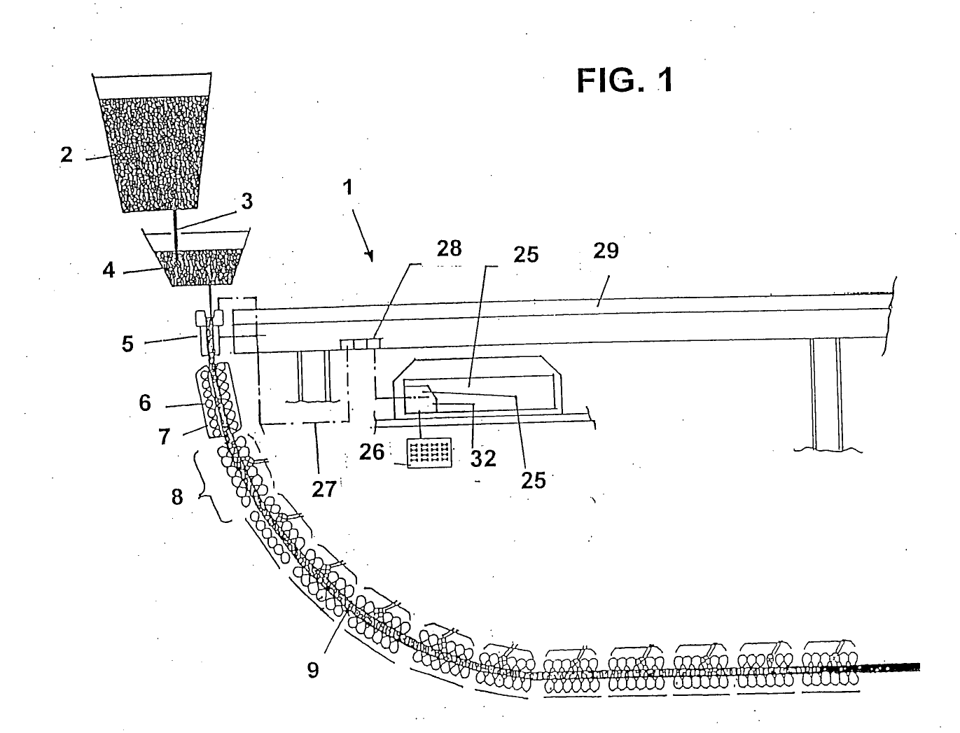

FIG. 1 shows a side view of a continuous casting machine, including the shop framework;

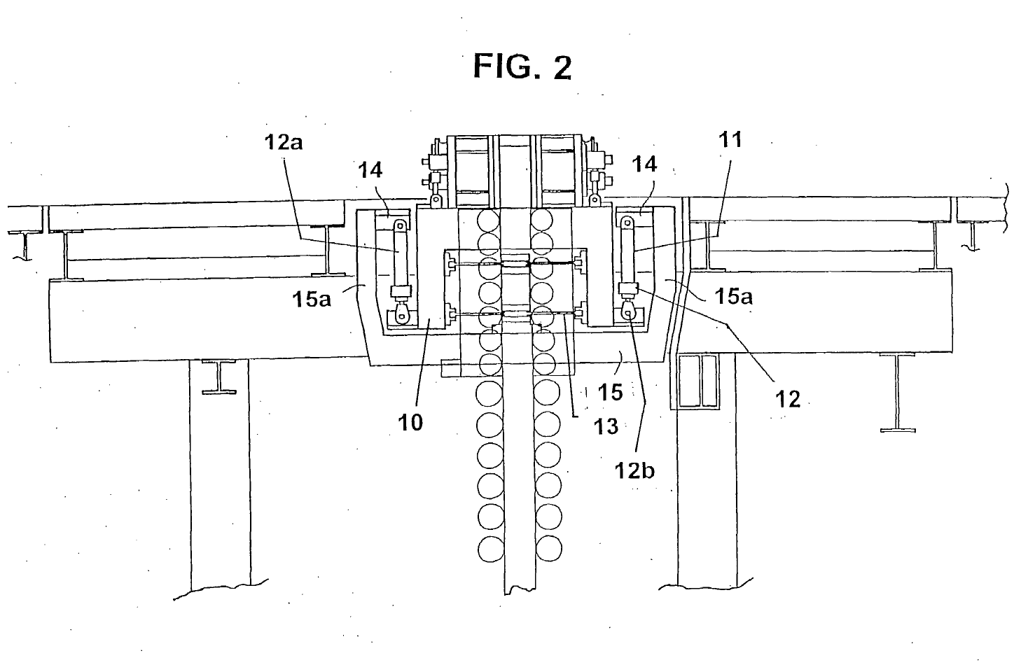

FIG. 2 shows a vertical section through a lifting table, including a continuous casting mold; and

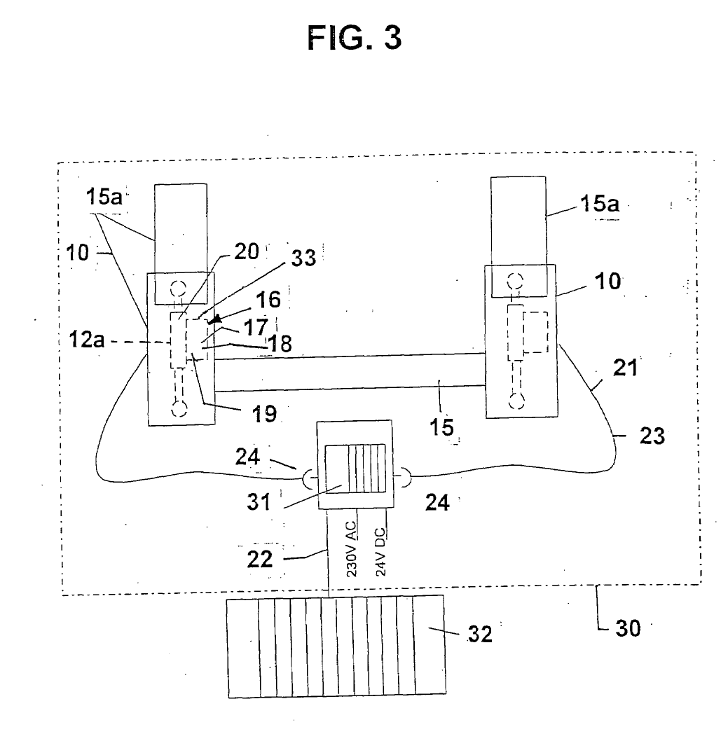

FIG. 3 shows a simplified view of a block diagram showing the lifting table which is supported on a plurality of piston-cylinder units.

The continuous casting machine 1 (FIG. 1) is operated from a casting ladle 2 with liquid steel material 3 which is cooled in the edge area with a strand shell proceeding from the casting ladle 2 in a tundish vessel 4 and then through a continuous casting mold 5. In so doing, it passes through a steam chamber 6 and is guided and moved in an increasingly solidified state by backup roller pairs 7. Backup roller pairs 7 form backup roller segments 8. The cast strand 9 which is still partially liquid in the interior and is solidified on the exterior continues to cool off and is bent back, i.e., straightened, in the horizontal during cooling and solidification.

The continuous casting mold 5 (FIG. 2) is mounted on a lifting table 10 of the continuous casting machine 1. The lifting table 10 is provided with an oscillating drive 11 comprising at least two, four in the embodiment example, piston-cylinder units 12 together with leaf spring pairs 13. The respective piston-cylinder units 12 are articulated in a stationary manner with the hydraulic cylinder 12a, at upper transverse legs 14 in the embodiment example, and connected by the piston head 12b to the lifting table 10 by additional, lower transverse legs 14. Together with a U-shaped supporting frame 15, the upper transverse legs 14 form a rigid structural unit with U-legs 15a.

As is shown in FIG. 3, field measuring devices 16 are provided which comprise a valve block 17 with a regulating valve 18 and pressure transducers 19 and further comprise position sensors 20 integrated in the hydraulic cylinder 12a.

The electrical connections 21 for the field measuring devices 16 comprise signal-carrying BUS lines 22. The signals of the field measuring devices 16 are guided to a control/regulating station 25 (FIG. 1) in cable bundles 23 provided with plug-in connection 24 and, after being processed, are guided back into the associated actuators, e.g., a valve stand 26.

Other signal lines 27 of the backup roller segments 8 and/or of the continuous casting mold 5 are connected by a terminal box 28 into the control/regulating station 25. The area of a shop framework 29 in which the control/regulating station 25 is arranged is protected but is easily surveyed from the latter.

The electrical connections 21 are connected to an axle regulator 31, respectively, in the vicinity 30 of the lifting table 10 in the cable bundles 23. The axle regulator 31 communicates via the BUS lines 22 of a fieldbus with a memory-programmable control 32 (FIG. 3) provided in the control/regulating station 25.

The field measuring devices 16 are connected, respectively, to the lifting table 10 by the plug-in connection 23 (FIG. 3) and can easily be disconnected, switched off or reconnected.

According to FIG. 3, lifting modules 33, each with two position sensors 20, two regulating valves 18 and two pressure transducers 19, are formed for every individual hydraulic cylinder 12a.

The axle regulators 31 are arranged inside a protected terminal box 34 which can be cooled by air or water.

Basically, the axle regulators 31 are used for fieldized signal processing in the hydraulic circuit of the lifting table 10 with the continuous casting mold 5 and the hydraulic piston-cylinder units 12. The signals are acquired, transmitted to the memory-programmable control 32 and processed, and the corrected signals are sent back to the respective actuator.

### REFERENCE NUMERALS

1 continuous casting machine
2 casting ladle
3 liquid steel material
4 tundish vessel
5 continuous casting mold
6 steam chamber
7 backup roller pair
8 backup roller segment
9 cast strand
10 lifting table
11 oscillating drive
12 piston-cylinder unit
12a hydraulic cylinder
12b piston rod head
13 leaf spring pair
14 transverse leg
15 U-shaped supporting frame
15a U-leg
16 field measuring device
17 valve block
18 regulating valve
19 pressure transducer
20 position sensor
21 electrical connection
22 BUS line
23 cable bundle
24 plug-in connection
25 control/regulating station
26 valve stand
27 signal line
28 terminal box
29 shop framework
30 vicinity
31 axle regulator
32 memory-programmable control
33 lifting module

1-7. (canceled)

8. Controlling and/or regulating device for a lifting table (10) supporting a continuous casting mold (5) in a continuous casting machine (1) for liquid metal, in particular for liquid steel material (3), comprising an oscillating drive (11) which transmits upward motion and downward motion to the lifting table (10) and the continuous casting mold (5), which upward and downward motion being generated by a plurality of stationary piston-cylinder units 912) which are articulated at the lifting table (10); local measuring devices (16) for each piston-cylinder unit (12) in form of, respectively, a valve block (17) with a regulating valve (18) and a plurality of pressure transducers (19), and in form of a position sensor (20); hydraulic cylinder (12a) and an elevated control/regulating stations,
characterized in that
in the vicinity of the lifting table, an axle-regulator (31) with a microprocessor is provided, wherein an application software runs on the microprocessor for regulating the movement of axes in form of separate piston-cylinder units of the lifting table in real time, and in that the application software is adaptable to the respective type of the separate piston-cylinder units and the type of the position feedback by parameters.

9. Controlling and/or regulating device according to claim 8, characterized in that the application software is formed to control the movement of the piston-cylinder units in accordance with signals of the field measuring devices and in accordance with reference values and a starting movement which were preset from the elevated control and/or regulating station (25) in the axle regulators (21) via a fieldbus line (22).
